(19) United States
(12) Patent Application Publication
(10) Pub. No.: US 2026/0086906 A1
(43) Pub. Date: Mar. 26, 2026

(54) ARTIFICIAL INTELLIGENCE IN TEST AND MEASUREMENT ENVIRONMENTS

(71) Applicant: Tektronix, Inc., Beaverton, OR (US)

(72) Inventors: Archana I. Akkalakot, Bengaluru (IN); Keith D. Rule, Beaverton, OR (US); Nitin Khaneja, Bengaluru (IN); Prashanth Thota, Tigard, OR (US)

(21) Appl. No.: 19/327,177

(22) Filed: Sep. 12, 2025

Related U.S. Application Data
(60) Provisional application No. 63/709,375, filed on Oct. 18, 2024.

(30) Foreign Application Priority Data
Sep. 25, 2024 (IN) 202421072357

(51) Int. Cl. G06F 11/22; G06F 11/263; G06N 3/0475

(52) U.S. Cl. CPC G06F 11/2263; G06F 11/2268; G06F 11/2273; G06F 11/263; G06N 3/0475

(57) ABSTRACT

A test and measurement system includes one or more test and measurement instruments at least one of which connects to a device under test (DUT), one or more memories, a generative artificial intelligence (AI) model connected to the one or more test and measurement instruments, and the one or more memories, and one or more processors to provide an artificial intelligence (AI) assistant as an interface to the generative AI model, present a user interface that allows a user to enter a prompt, use the AI assistant to translate the prompt into one or more queries for the generative AI model, send commands to the test and measurement instrument connected to the DUT to perform one or more tests on the DUT, take results from the one or more tests and convert them to user-interpretable results, and provide the user with results from the prompt at the user interface.

### CROSS-REFERENCE TO RELATED APPLICATIONS

This disclosure claims priority under 35 U.S.C. § 119 to Indian Provisional Patent Application No. 202421072357, titled “AI ASSISTANT FOR CUSTOM VISUALIZATION, ANALYTICS, AND DATA TRANSFORMATION,” filed on Sep. 25, 2024, and is a non-provisional of and claims benefit from U.S. Provisional Patent Application No. 63/709,375, titled “SIGNAL ANALYSIS AND SIGNAL GENERATION USING ARTIFICIAL INTELLIGENCE AND LARGE LANGUAGE MODELS,” filed on Oct. 18, 2024, the disclosures of both of which are incorporated herein by reference in their entirety.

### TECHNICAL FIELD

This disclosure relates to test and measurement systems, more particularly to test and measurement systems using artificial intelligence for customizable signal analysis, signal generation, and data visualization.

### BACKGROUND

Design engineers and test engineers use test and measurement instruments in domains such as aerospace, automotive, defense, and electronics to debug, validate, perform quality control, etc., on devices under test. The tests check for compliance with standards, error detection, performance measurement and many other parameters and characteristics.

However, the existing solutions limit the user's ability to analyze and visualize the signals provided, which operate on the data schema supplied within the system. This provides a fixed and limited analysis for users, limiting their ability to analyze the data for their specific needs.

Current testing tools handle specific types of analysis such as signal measurements, protocol decoding, triggers, search, plots, annotations, signal generations, and embedding/de-embedding of codes. The user selects the tools based upon a test scenario to try and debug a problem, validate a device, etc. The conventional approach assumes that the user knows how the tools work, how to use the tools and that the user knows the specification with which the user is working. Current systems can handle structured queries but have rigid structures and are pre-defined with little flexibility.

### BRIEF DESCRIPTION OF THE DRAWINGS

FIG. 1 shows a diagram of an embodiment of a test and measurement system.

FIG. 2 shows an example of a complex system.

FIG. 3 shows an embodiment of a process flow for an AI-assisted test and measurement system.

FIG. 4 shows a diagram of layers of signal analysis.

FIG. 5 shows a diagram of a signal with landmarks.

FIG. 6 shows a diagram of physical layer definitions.

FIG. 7 shows a diagram of a decode layer.

FIGS. 8-13 show images of a response to a prompt in an AI-assisted test and measurement system.

### DESCRIPTION

The embodiments herein use an artificial intelligence (AI) assistant to allow the user to customize how data is represented, visualized, and saved. The embodiments allow the user to use prompts and the test and measurement environment that describe how data should be annotated, drawn, or saved. The resulting behavior created by the prompt or set of prompts can be named, saved, and replayed. The behaviors can be templated to be generalized to allow the same actions to be applied to different inputs. The behaviors can be added to the user interface as “built in” capabilities, also referred to as “tools.” The embodiments can take the environment in which the user works as context-specific capabilities. For example, if the instrument has an I2C protocol present, a prompt that says, “Split the devices being tested into swim lanes,” the AI assistant knows a device has a unique address and that the user wants to show addresses in their own time-aligned “tiled” lane. The AI assistant provides an environment in which capabilities can be mixed, matched, and composed in new ways. Adding new capabilities adds to the pallet of available behaviors.

The embodiments provide these behaviors, meaning the way that the various instruments and other resources in the test and measurement environment behave, in what one could view as “tools.” A tool as used herein refers to a set of operations, instrument or other resource behaviors and/or capabilities, that the user can access as needed to achieve the goals of testing and measuring the performance of all aspects of a complex system. Currently, tools are provided by vendors to users of the vendor's systems to allow the user to perform tasks, or cause the system to behave, in particular ways. Underlying assumptions of these tools include that the user knows how the tools work, assumes the user knows how to use the tool, and that the user understands the particular test specification or protocol well enough to know whether the device(s) operates correctly.

The AI assistant, and its underlying generative AI model, such as a large language model, accesses the specification(s) for training, and then can create the necessary tools based upon the specification. In one embodiment, the tools can name objects when used on a signal undergoing analysis. The AI assistant has awareness of the tools and their capabilities, and as mentioned, above, can combine, mix, and match the tools as needed, based upon the user query/prompt. The tools can create a point solution to debug a customer specific problem, provide analysis of data of a particular type or source, and render the results and/or the data in a manner that the user understands. Essentially, the user interacts with the AI assistant and the AI assistant gathers the data needed and communicates with the user using the tools that the AI assistant has developed.

As used herein, the following terms have specific definitions. The term “a user prompt” or “prompt” means the user's input into the AI assistant user interface. The term “query” is a structured request sent to analysis engine and rendering engines with precise specifications of what to do with available measurement data. Queries operate on a pool of information from sources that include, but are not limited to, oscilloscope channels that receive data, math functions, protocol decodes, measurement populations, search results, spectral data, stored files, and data from multiple connected instruments.

The term “analysis engine” means a software component that processes input data, applies specific rules or algorithms, and outputs the results. It often transforms the data from one format, structure, or representation into another to enable further use or insight. The analysis engine selects the data source, such as which channels on which instruments, processes operations such as calculations, statistical analysis, and filtering, and compares the results against specifications for compliance as needed. The term “rendering engine” means a software component that takes the processed output from an analysis engine and converts it into a visual form, such as charts, graphs, images, or interactive displays, so that humans can easily interpret the data. It displays or shows the results from the analysis engine. This may include plots, swim lanes, waveforms with and without annotation, color coding, and layout and display parameters.

As mentioned previously, current queries have to follow very specific formats and must designate the various components and parameters. The AI assistant and generative AI process functions much differently. The AI assistant parses the user prompt to identify data sources, analysis needs, and display requirement. It uses knowledge of current instruments, protocols, available data, and data sources as context for the prompt. The AI assistant then creates the analysis and rendering queries in the proper format and content for the given parameters derived from the user prompt. The AI assistant can also use saved query patterns and available tools, as well as save new query patterns as templates for later use.

Regarding tools, the AI assistant can use pre-existing tools, and/or make “created” tools from the available capabilities of the system instead of having fixed, pre-programmed measurement functions, as an example. The AI assistant can create and use modular tools that can be connected together as needed, where each tool does one specific job and passes the results of that job to the next tool. Examples include, but are not limited to period detectors, root mean square (RMS) measurements, various error measurements and detectors, swim lane rendering, such as creating visual displays with separate lanes for data streams. The AI assistant automatically selects the right measurement tools, connects them as needed in custom sequences, sets the appropriate parameters, generates the structured query(ies), and then executes the measurement chain.

As examples, the user could enter a prompt, “Measure the power consumption during each clock cycle,” and the AI assistant would break that down into “Find clock periods→Measure RMS power→Display results.” A more complex prompt could be, “Show communication errors organized by device address,” which the AI assistant would break down as, “Decode protocol data→Find errors→Group by address→Create visual display.” These comprise just some examples, more examples are provided below.

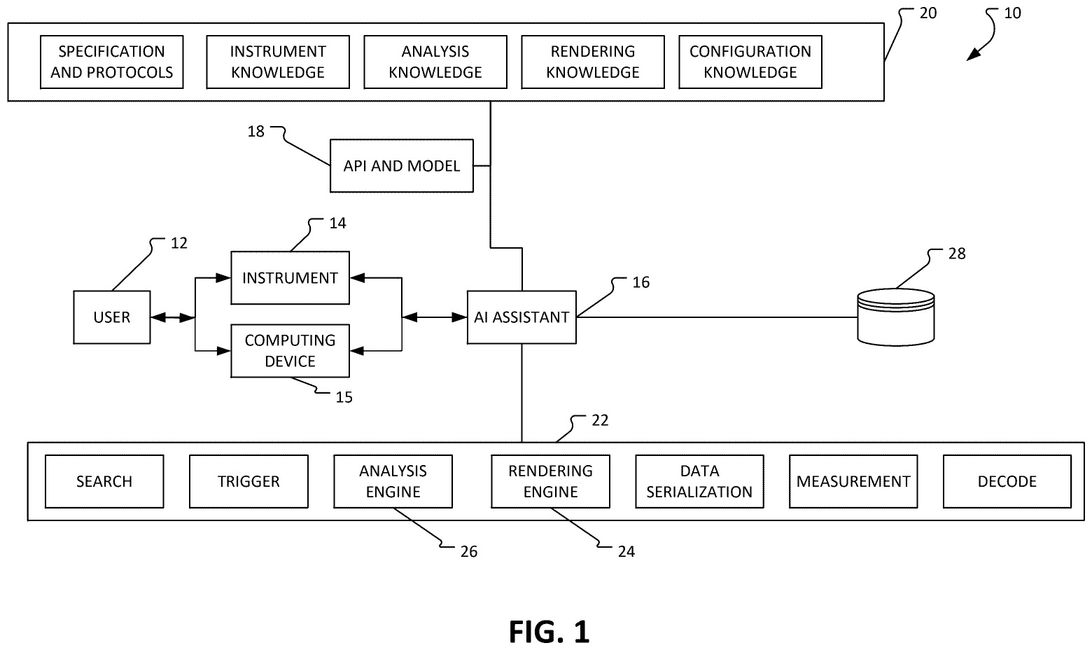

FIG. 1 shows a system diagram of a test and measurement system having an AI assistant 16. The user 12 interacts with the AI assistant 16 through a test and measurement instrument 14, such as an oscilloscope. Alternatively, the user 12 may interact with the instrument 14 through the AI assistant 16 on a separate computing device. User 12 would access the AI assistant 16 on a computing device 15, which would then connect to instrument 14, which represents multiple instruments to which the AI assistant 16 may connect. The AI assistant has an application programming interface (API) to access a generative AI model 18, such as a large language model (LLM), a large multimodal model (LMM), or other generative AI model.

Model 18 undergoes training that may include all or some of the subjects in the knowledge set 20. This allows the model to interact with the user through a language recognition interface, like natural language processing (NLP) and recognize the words used by the user 12 when the user makes a request from AI system. The AI assistant 16 may provide the user interface to the model 18 and may have its own language recognition interface, as well as access to some or all of the knowledge in the knowledge set 20.

As user 12 enters requests in the forms of prompts, the AI assistant 16 will send those prompts as queries to the model as needed. The AI assistant 16 may have the capability to operate without relying on the model, depending upon the situation, as will be discussed in more detail further. As will be discussed in more detail, the user interactions, such as prompts that get converted to commands and queries, results, etc., may be stored in data store 28.

In some embodiments, the AI assistant and/or the model may employ various tools from the tool set 22. The system may already have these tools, referred to here as “pre-existing tools,” such as the rendering engine 24 and the analysis engine 26. Others may be created and stored by the AI assistant, referred to here as “created tools,” including additions to pre-existing tools. For example, the rendering engine may produce certain data displays for the user to see the results, and the AI assistant may create other tools for those displays, such as annotations, plots, etc. The use of the AI assistant 16 and the model 18 allows the system to translate between signals and data received from devices under test (DUT) and provide context and human-interpretable results and analysis to allow the user 12 to measure, analyze, debug, and perform other tasks for complex systems. The AI assistant can use pre-existing tools in new and unique ways, connecting them together, creating and using created tools in new and unique ways, and mix and match between pre-existing and created tools, all to produce new workflows as needed.

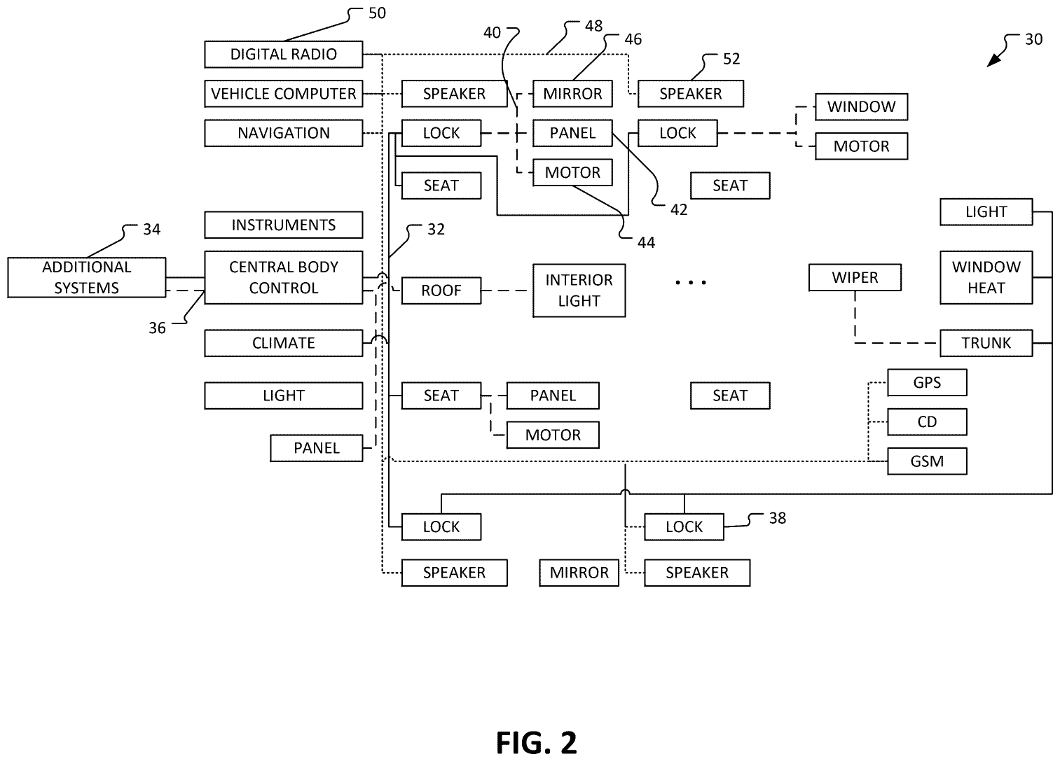

As an example, without limitation, FIG. 2 shows a portion 30 of a complex system that requires at least one of testing, measuring, and debugging. In this example, the system comprises an automobile. In addition to the various components shown, the system includes three different types of buses. The solid lines indicate components that communicate via a controller area network (CAN) 32 such as the central body control 36 and additional systems in the drive train 34, and more simple devices like door lock 38. The dashed lines indicate components that communicate via a local interconnect network (LIN) 40 such as the door panel controls 42 and the associated motor 44 on the passenger side mirror 46. The dotted lines indicate components that communicate via a media-oriented system transport (MOST) system 48 like the digital radio 50 and speaker 52. This diagram, while only showing a portion of the components, systems, and buses underscores the complexity of the test and measurement environment, and one can see how the use of an artificial intelligence assistant would assist with running the tests, gathering the data, analyzing the data, and then presenting the user with the results on a user interface, such as by rendering graphics, measurements, readings, etc.

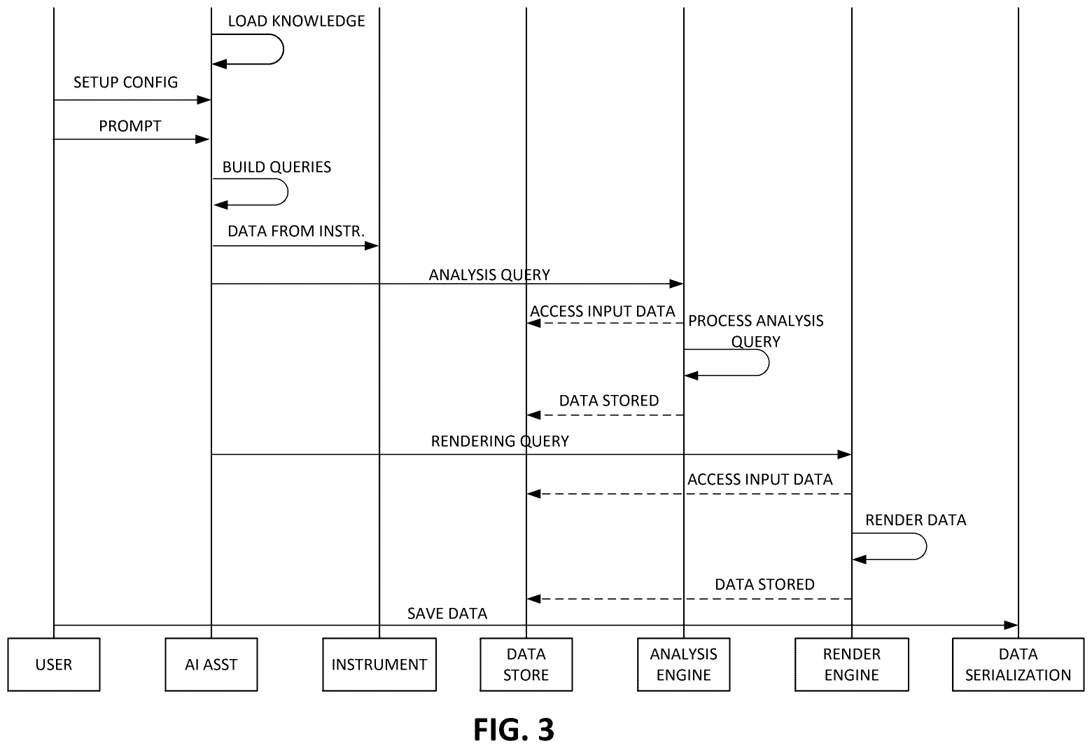

FIG. 3 shows an embodiment of a process in which the AI assistant handles a user prompt to analyze and render information from one or more test and measurement instruments. As discussed above, the AI assistant may load knowledge prior to any user interactions. The knowledge may include, as examples without limitation, instrument knowledge for instrument(s) in the test and measurement system, analysis knowledge involving the various forms or analysis and any calculations or operations performed as part of the analysis, rendering knowledge as to how to render the results, and instrument configuration knowledge about how to configure and operate the instruments as needed. This may involve SCPI (standard commands for programmable instruments) commands, IP addresses for the instruments, etc.

The user specifies the setup configuration and provides a prompt, or request, for analysis. The AI assistant then analyzes the prompt to build an analysis query and a rendering query. The AI assistant then gets the data from the instrument, either by request or by accessing the instrument. The data may then be stored in the data store. The AI assistant then submits the analysis query to the analysis engine. The analysis engine may comprise a task that is performed by the AI model or may comprise a pre-existing software program that performs the analysis indicated by the query.

In response to the query, the analysis engine accesses the input either from the data store or other location where the AI assistant may have stored the data. The analysis engine then processes the analysis query and stores the analysis data in the data store.

The AI assistant then sends the rendering query or request to the rendering engine. The rendering engine then accesses the analysis data and renders the data on a user interface so the user can see the results of the analysis. The user can then save the data by sending to a data serializer tool.

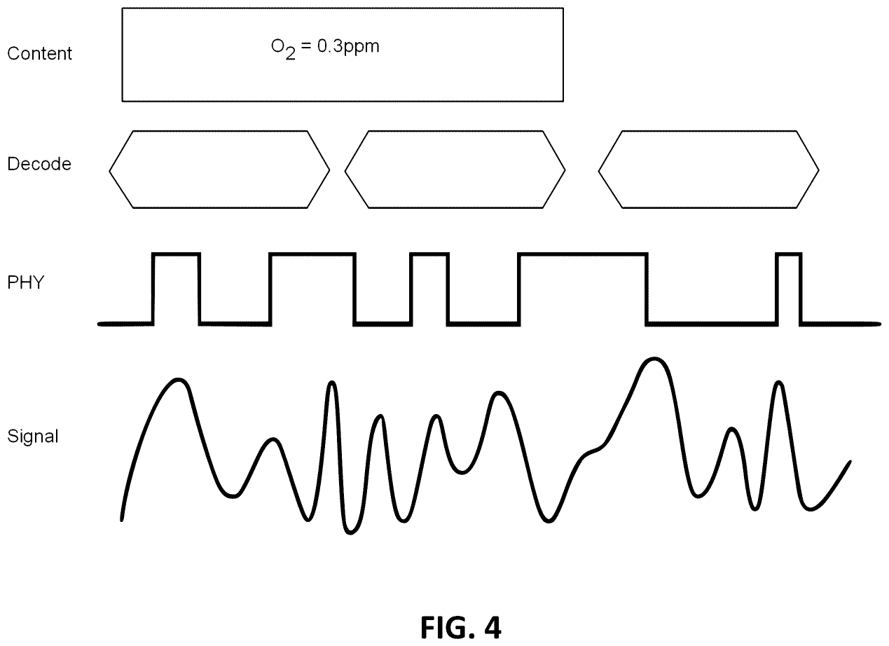

An important aspect of the process of the embodiment above lies in the nature of the instrument data and the role the AI assistant fills by converted the meaning of the signal or data gathered from the instrument and converting it into human interpretable and understandable form. FIG. 4 shows the progression of a signal received at an instrument to a final reading of measurement that a user can understand. The first layer is the signal layer. For example, the signal could comprise a change in voltage or current over a time period shown by the length of the signal. The PHY, or physical layer, converts the signal into a digital representation of the analog signal. The decode layer then converts the signal at the PHY layer into bit sequences based upon a particular protocol, such as a communication protocol. The original signal was generated in accordance with this protocol, and as the signal is converted, the process fits the signal into the proper format for the protocol. This allows the signal to be compared to the test specification to see if the signal meets the compliance requirements.

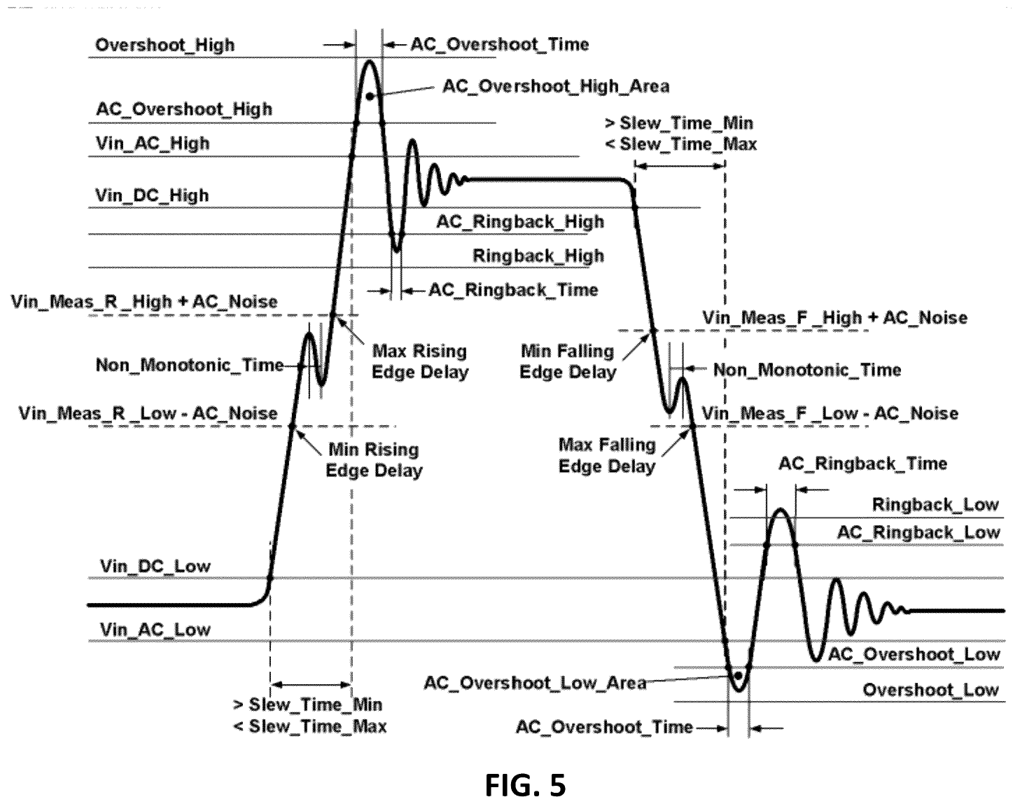

FIG. 5 shows an example of an analog signal and the various characteristics of the signal that have significance for analysis of the signal. These characteristics and landmarks may have significance as to the performance of the DUT that generated them. The performance of the DUT will generally be measured in terms of the test specification.

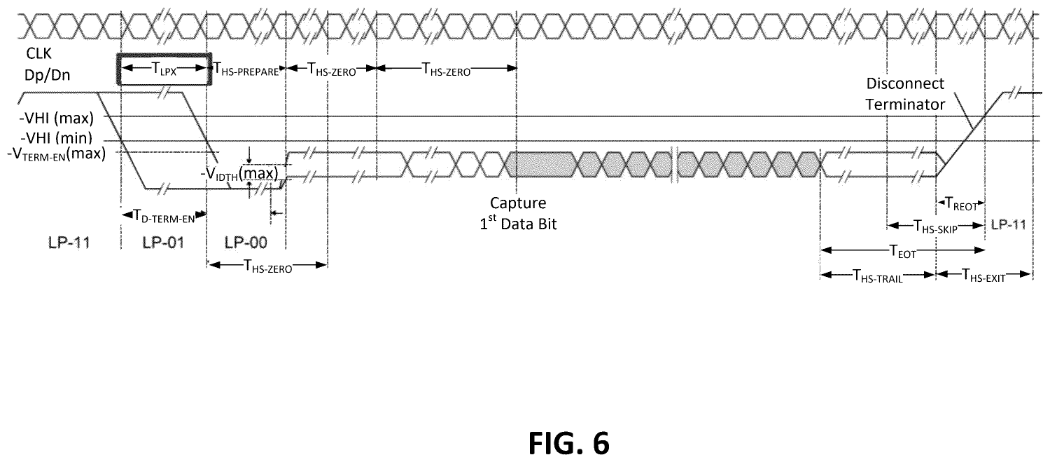

FIG. 6 shows the resulting physical layer conversion of the key landmarks from the signal of FIG. 5. The items shown in the diagram represent the landmarks that represent the characteristics of the signal. For example, T_{LPX} refers to a timing parameter related to a transition from low power (LP) to high-speed mode. The observable characteristic here may require that T_{LPX} be greater than some value.

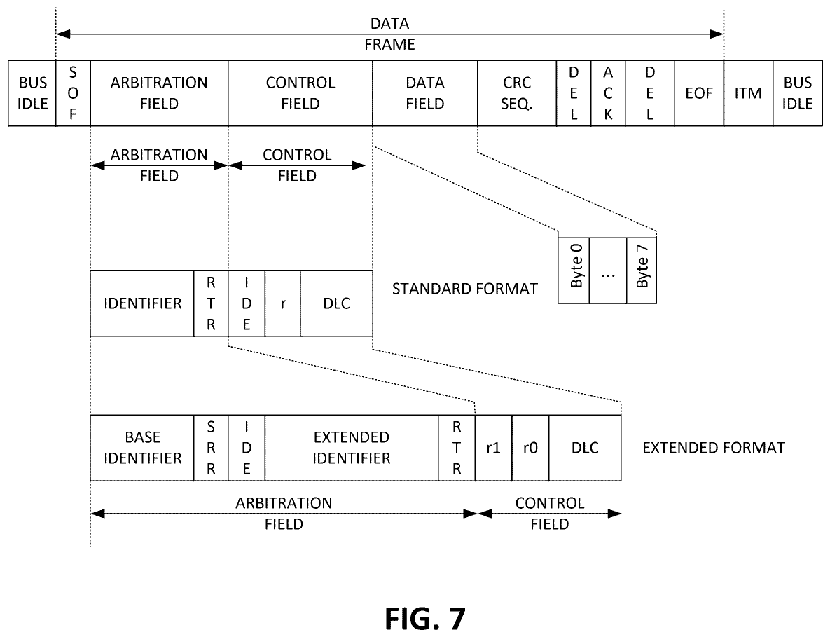

FIG. 7 shows the decoding performed to take the physical definitions in the PHY layer and turn them into bit sequences based upon a protocol definition. The various fields and bits of the protocol definition are used to translate the signals from a bus, such as those discussed in FIG. 2, into meaningful bit sequences. These bit sequences then require the translation into something humans can understand, shown as content in FIG. 4.

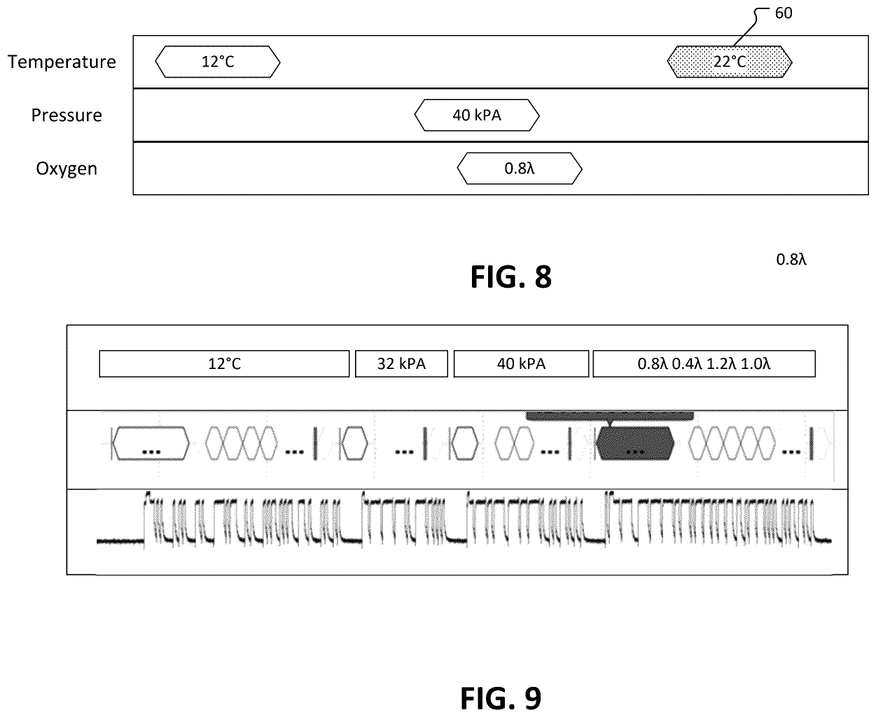

The process of achieving this result becomes much simpler for the user when using the AI assistant as shown by the embodiment of the message flow shown in FIG. 2. FIGS. 8-13 show similar results to the content layer of FIG. 4 in response to various prompts.

The user may be looking into the vehicle sensors, such as temperature, pressure, and oxygen. In this example, these sensors are connected to the vehicle's CAN bus, so the user wants to analyze, visualize and debug the data communication on the CAN bus.

FIG. 8 shows the response to a user prompt,

“Show me the frames for devices <Temperature>, <Pressure>, and <Oxygen> in swim
lanes. Show <data frames> in <white> and remote frames in <gray>. “

As can be seen in FIG. 8, the temperature, pressure, and oxygen readings have undergone decoding from the bus and are provided to the user in an easy-to-understand diagram. The data 60 in the temperature lane of 22° C. is shown in the figure as patterned.

FIG. 9 shows the results from a prompt that said,

“Show me the data for the devices in <readable format> along with <input signal> and
<decoded data>.”

The readable data is shown in the top line, with the decode in the middle and the input signals at the bottom.

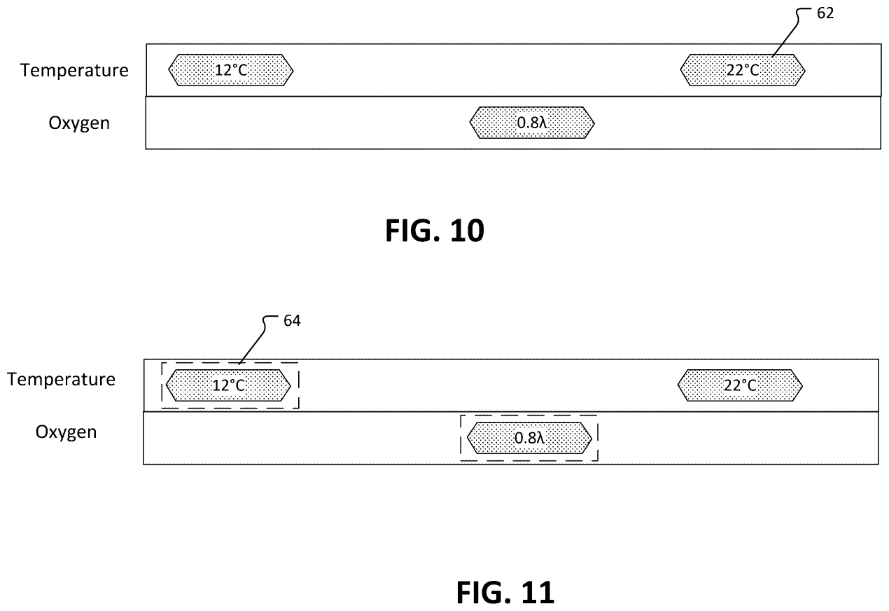

FIG. 10 shows the results of a prompt that said,

“Show me the <temperature> and <oxygen> frames with failures and draw them in
<red>.”

In FIG. 10, the gray represents red, and the frames that meet the request are shown as patterned rather than red, such as 62.

FIG. 11 shows the results from a prompt that said,

“Annotate the frames with failure whose <rise time> is <outside limits>. The <inside
limits> are <10ns> to <20ns>.”

The two frames shown in FIG. 11 that have the dashed boxes such as 64 are those that are outside the limits.

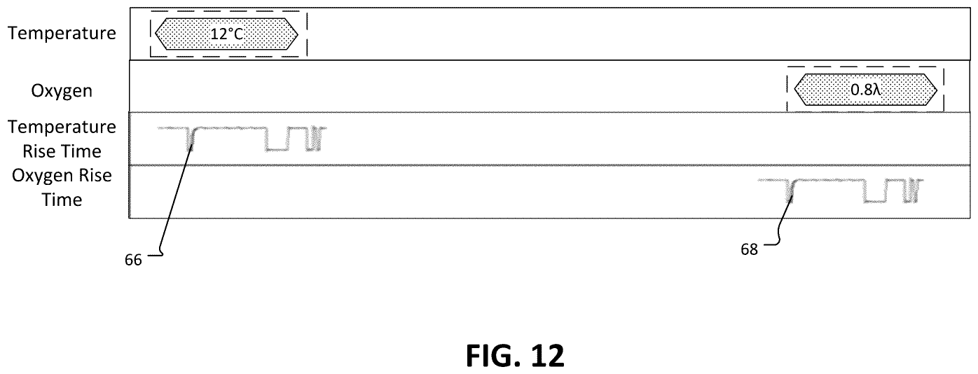

FIG. 12 shows the results from follow-on prompt that said,
“Add the waveforms for the frames having <risetimes> errors.”
   As can be seen in FIG. 12, the two waveforms can be seen with the slightly heavier lined at 66 and 68 that shows the rise time errors.

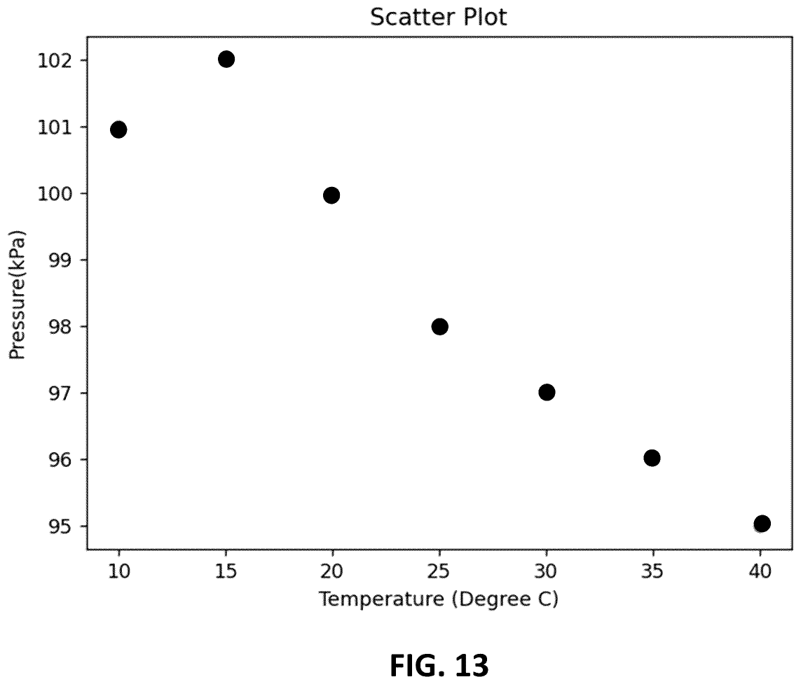

FIG. 13 shows a scatter plot in response to a prompt that said, “Show me the data between <temperature> and <pressure> using a scatter plot.”

As another example, the AI assistant could be asked to monitor something over some period of time. For example, “Show me the statistics of <temperature>. Continue monitoring for next 1 hour and save this data. <Filename>”

This may result in the below table:

Address 101

| | |
|---|---|
| Mean (Degree C.) | 30 Degree C. |
| Median (Degree C.) | 43 Degree C. |
| Maximum (Degree C.) | 45 Degree C. |
| Minimum (Degree C.) | 10 Degree C. |

In this manner, users can communicate with the instrument using natural language and request data in various formats, enabling quicker understanding, resolution of issues, and debugging of problems. The AI assistant highlights errors and presents data clearly. Users can analyze data in the context of their setup. The approach detects anomalies in the underlying layers and presents errors in a higher-level language and visual representations. The prompts are converted into queries and commands, such as the one above regarding monitoring for an hour, and this can be saved to allow use of it as a template. The AI assistant can also create a “monitoring” tool that the user may or may not see, but that will speed the AI assistant's processes further. The AI assistant dynamically creates new combinations of measurement tools based on natural language inputs enabling custom measurement and analysis workflows that are not possible with current fixed user interfaces.

In this manner, an AI assistant in conjunction with a generative AI model can make the test and measurement environment far more user-friendly and allow for better understanding of issues that arise when testing, analyzing, and debugging DUTs, whether simple DUTs or DUTs in complex environments with multiple protocols and standards involved.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a test and measurement system, comprising: one or more test and measurement instruments comprising at least one test and measurement instrument having one or more ports to connect the at least one test and measurement instrument to a device under test (DUT); one or more memories including test and measurement knowledge; a generative artificial intelligence (AI) model connected to the one or more test and measurement instruments, and the one or more memories; one or more processors configured to execute code that causes the one or more processors to: provide an artificial intelligence (AI) assistant as an interface to the generative AI model; present a user interface that allows a user to enter a prompt for interpretation by the AI assistant; use the AI assistant to translate the prompt into one or more queries for the generative AI model; send commands to at least one of the test and measurement instruments to perform one or more tests on the DUT in response to the prompt; take results from the one or more tests and convert them to user-interpretable results; and provide the user with results from the prompt at the user interface.

Example 2 is the test and measurement system of Example 1, wherein the one or more processors are further configured to execute code to cause the one or more processors to provide the AI assistant with information about an environment of the test and measurement system.

Example 3 is the test and measurement system of Example 2, wherein the code that causes the one or more processors to provide the AI assistant with information about the environment comprises code that causes the AI assistant to access one or more of testing specifications, general test and measurement knowledge, knowledge about specific instruments in the environment, analysis knowledge, rendering knowledge, and knowledge about one or more of devices and systems being tested in the environment.

Example 4 is the test and measurement system of any of Examples 1 through 3, wherein the one or more processors are further configured to execute code to cause the AI assistant to access one or more pre-existing tools in response to the prompt.

Example 5 is the test and measurement system of Example 4, wherein the one or more processors are further configured to execute code to cause the AI assistant to connect together one or more of the pre-existing tools in response to the prompt.

Example is the test and measurement system of Example 4, wherein the one or more pre-existing tools include search, trigger, analysis, rendering, data serialization, measurement, and decoding.

Example 7 is the test and measurement system of any of Examples 1 through 6, wherein the one or more processors are further configured to execute code to cause the AI assistant to create one or more created tools in response to the prompt.

Example 8 is the test and measurement system of Example 7, wherein the one or more processors are further configured to execute code that causes the AI assistant to connect the one or more created tools into a workflow.

Example 9 is the test and measurement system of any of Examples 1 through 8, wherein the one or more processors are further configured to save the prompt and the commands as a template.

Example 10 is a method, comprising: providing an artificial intelligence (AI) assistant as an interface to a generative AI model; presenting a user interface that allows a user to enter a prompt for interpretation by the AI assistant; using the AI assistant to translate the prompt into one or more queries; sending commands to one or more test and measurement instruments in a test and measurement system to perform one or more tests on a device under test (DUT) in response to the prompt; taking results from the one or more tests and converting them to user-interpretable results; and providing the user with results from the prompt at the user interface.

Example 11 is the method of Example 10, further comprising providing the AI assistant with information about an environment of the test and measurement system.

Example 12 is the method of Example 11, wherein providing the AI assistant with information about the environment comprises using the AI assistant to access one or more of testing specifications, general test and measurement knowledge, knowledge about specific instruments in the environment, analysis knowledge, rendering knowledge, and knowledge about one or more of devices and systems being tested in the environment.

Example 13 is the method as claimed of any of Examples 10 through 12, further comprising using the AI assistant to access one or more pre-existing tools in response to the prompt.

Example 14 is the method of Example 13, wherein using the AI assistant to access one or more tools pre-existing comprises using the AI assistant to connect the pre-existing tools into a new workflow.

Example 15 is the method of Example 13, wherein the one or more pre-existing tools include search, trigger, analysis, rendering, data serialization, measurement, and decoding.

Example 16 is the method of any of Examples 10 through 15, further comprising having the AI assistant create one or more created tools in response to the prompt.

Example 17 is the method of Example 16, wherein having the AI assistant create the one more created tools comprises having the AI assistant connect the one or more created tools together in new workflow.

Example 18 is the method of Example 10, further comprising saving the prompt and the commands as a template.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A test and measurement system, comprising:
one or more test and measurement instruments comprising at least one test and measurement instrument having one or more ports to connect the at least one test and measurement instrument to a device under test (DUT);
one or more memories including test and measurement knowledge;
a generative artificial intelligence (AI) model connected to the one or more test and measurement instruments, and the one or more memories;
one or more processors configured to execute code that causes the one or more processors to:
provide an artificial intelligence (AI) assistant as an interface to the generative AI model;
present a user interface that allows a user to enter a prompt for interpretation by the AI assistant;
use the AI assistant to translate the prompt into one or more queries for the generative AI model;
send commands to at least one of the test and measurement instruments to perform one or more tests on the DUT in response to the prompt;
take results from the one or more tests and convert them to user-interpretable results; and
provide the user with results from the prompt at the user interface.

2. The test and measurement system as claimed in claim 1, wherein the one or more processors are further configured to execute code to cause the one or more processors to provide the AI assistant with information about an environment of the test and measurement system.

3. The test and measurement system as claimed in claim 2, wherein the code that causes the one or more processors to provide the AI assistant with information about the environment comprises code that causes the AI assistant to access one or more of testing specifications, general test and measurement knowledge, knowledge about specific instruments in the environment, analysis knowledge, rendering knowledge, and knowledge about one or more of devices and systems being tested in the environment.

4. The test and measurement system as claimed in claim 1, wherein the one or more processors are further configured to execute code to cause the AI assistant to access one or more pre-existing tools in response to the prompt.

5. The test and measurement system as claimed in claim 4, wherein the one or more processors are further configured to execute code to cause the AI assistant to connect together one or more of the pre-existing tools in response to the prompt.

6. The test and measurement system as claimed in claim 4, wherein the one or more pre-existing tools include search, trigger, analysis, rendering, data serialization, measurement, and decoding.

7. The test and measurement system as claimed in claim 1, wherein the one or more processors are further configured to execute code to cause the AI assistant to create one or more created tools in response to the prompt.

8. The test and measurement system as claimed in claim 7, wherein the one or more processors are further configured to execute code that causes the AI assistant to connect the one or more created tools into a workflow.

9. The test and measurement system as claimed in claim 1, wherein the one or more processors are further configured to save the prompt and the commands as a template.

10. A method, comprising:
providing an artificial intelligence (AI) assistant as an interface to a generative AI model;
presenting a user interface that allows a user to enter a prompt for interpretation by the AI assistant;
using the AI assistant to translate the prompt into one or more queries;
sending commands to one or more test and measurement instruments in a test and measurement system to perform one or more tests on a device under test (DUT) in response to the prompt;
taking results from the one or more tests and converting them to user-interpretable results; and
providing the user with results from the prompt at the user interface.

11. The method as claimed in claim 10, further comprising providing the AI assistant with information about an environment of the test and measurement system.

12. The method as claimed in claim 11, wherein providing the AI assistant with information about the environment comprises using the AI assistant to access one or more of testing specifications, general test and measurement knowledge, knowledge about specific instruments in the environment, analysis knowledge, rendering knowledge, and knowledge about one or more of devices and systems being tested in the environment.

13. The method as claimed as claimed in claim 10, further comprising using the AI assistant to access one or more pre-existing tools in response to the prompt.

14. The method as claimed in claim 13, wherein using the AI assistant to access one or more tools comprises using the AI assistant to connect the pre-existing tools into a new workflow.

15. The method as claimed in claim 13, wherein the one or more pre-existing tools include search, trigger, analysis, rendering, data serialization, measurement, and decoding.

16. The method as claimed in claim 11, further comprising having the AI assistant create one or more created tools in response to the prompt.

17. The method as claimed in claim 16, wherein having the AI assistant create the one more created tools comprises having the AI assistant connect the one or more created tools together in new workflow.

18. The method as claimed in claim 11, further comprising saving the prompt and the commands as a template.
